(19) United States
(12) Patent Application Publication
(10) Pub. No.: US 2016/0336771 A1
(43) Pub. Date: Nov. 17, 2016

(54) ENGINE ELECTRONIC CONTROL UNIT BATTERY CHARGE CONTROLLER

(71) Applicants: Kevin Joseph ARTUSIO, Winchester, VA (US); VOLVO TRUCK CORPORATION, Goteborg (SE)

(72) Inventor: Kevin Joseph ARTUSIO, Winchester, VA (US)

(21) Appl. No.: 15/111,266

(22) PCT Filed: Jan. 24, 2014
(86) PCT No.: PCT/US14/12842

§ 371 Date: Jul. 13, 2016

(51) Int. Cl. H02J 7/00; B60R 16/033

(52) U.S. Cl. CPC H02J 7/0026; B60R 16/033

(57) ABSTRACT

A system for adjusting a voltage level to which a battery is charged includes an alternator, a battery connected in series to the alternator, at least one electrical load element connected in parallel to the battery, a plurality of sensors connected to the battery and an engine electronic control unit having as inputs at least a signal from each of the plurality of sensors and providing a voltage control signal to the alternator.

### BACKGROUND

The present disclosure relates to vehicles such as trucks and more particularly, to systems and methods for reducing damage to vehicle batteries resulting from ambient variations.

Trucks, like most vehicles, use a battery. The performance of a battery deteriorates with usage and/or time. Battery manufacturers take these factors into account in determining the length of warranties offered to the customers. The battery is typically charged by an alternator while the vehicle (i.e. the engine) is running. The alternator charges the battery to a pre-specified or designated voltage level. Each battery is designed or intended to operate within a voltage range.

The alternator is rated for charging the battery at a constant voltage level (of 14.2 volts for example) and for providing current to any load connected to the battery. A load is any device or component that draws power from the battery and/or the alternator.

Trucks encounter a wide range of driving conditions including variations in temperatures. Battery performance can also be affected by ambient temperatures (i.e. ambient to the battery). An increase in the ambient temperature can damage the battery. In some cases, the battery can even explode. A decrease in temperature could also affect battery life and performance.

It is desirable to factor in the ambient temperature as a parameter in determining the voltage level to which the battery is charged.

### SUMMARY

In accordance with an exemplary embodiment, a system for adjusting a voltage level to which a battery is charged is disclosed. The system comprises: an alternator, a battery connected in series to the alternator, at least one electrical load element connected in parallel to the battery, a plurality of sensors connected to the battery, an engine electronic control unit (EECU) having as inputs at least a signal from each of the plurality of sensors and providing a voltage control signal to the alternator.

In accordance with another exemplary embodiment, a method for adjusting a voltage level to which a battery is charged is disclosed. The method comprises the steps of: charging the battery by an alternator, measuring a plurality of parameters associated with the battery, communicating the measured parameters to an engine electronic control unit (EECU), evaluating the measured parameters, generating a voltage control signal based on the evaluation, communicating the voltage control signal to the alternator and adjusting the supply voltage provided by the alternator to the battery based on the received control signal.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a system for regulating the voltage of an automotive battery;

FIG. 2 illustrates a system for regulating the voltage of an automotive battery in accordance with exemplary embodiments;

FIG. 3 illustrates a temperature/voltage relationship for a battery; and

FIG. 4 illustrates a method in accordance with exemplary embodiments.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

According to exemplary embodiments, a system for adjusting the voltage level to which a battery is charged is disclosed. An exemplary system monitors a vehicle battery's ambient temperature and provides a signal to the alternator via an engine electronic control unit (EECU). In accordance with the signal, the alternator adjusts its voltage output level (to which the battery is charged).

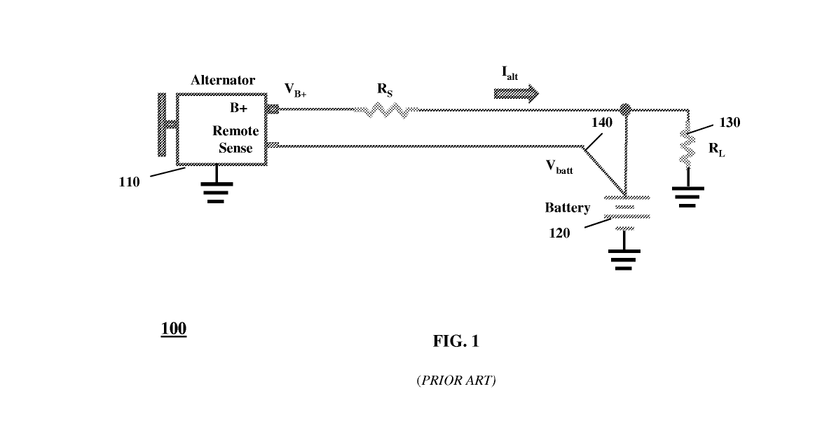

Prior to describing exemplary embodiments, an existing system for charging the automotive battery by an alternator is described herein with reference to FIG. 1. Charging System 100 includes an alternator 110, a battery 120 connected (in series) to the alternator and a load 130 connected (in parallel) to the battery (the load is also connected in series to the alternator). Alternator 110 may be rated to charge the battery to (and maintain the charge at) a pre-specified voltage level V_{B+}.

Alternator 110 includes a voltage regulator (not illustrated) for maintaining a constant voltage, V_{B+}. The connection between the alternator 110 and the battery 120 can include line resistance R_{S} resulting in a voltage drop across R_{S}. The voltage drop V_{RS} across line resistance R_{S} is the product of resistance R_{S} and alternator current Iₐₗₜ (i.e. V_{RS}=Iₐₗₜ*R_{S}).

A voltage sensor 140 measures voltage, V_{batt} at the battery and provides this measurement to the alternator 110. The line connecting battery 140 to alternator 110 has a small current, typically in the milliamp range at most and therefore, the voltage drop over this line is negligible. In contrast, Iₐₗₜ can be as much as 300 amps.

The voltage measurement provided by sensor 140 is used by alternator 110 to either increase or decrease a voltage output to the battery 120 in order to (attempt to) maintain (a constant value for) V_{B+} at the battery 120. The voltage output is increased if the voltage sensor measures a voltage below a desired or rated level for the battery. The voltage output from the alternator is decreased if the voltage sensor measures a voltage above a desired or rated level for the battery. If the voltage sensor measures a voltage level that is equal to the desired or rated level for the battery, the voltage output from the alternator is not altered or changed.

Recommended voltage levels of the battery are also affected by ambient temperature. Battery manufacturers recommend certain voltage levels for their batteries depending on the ambient temperature.

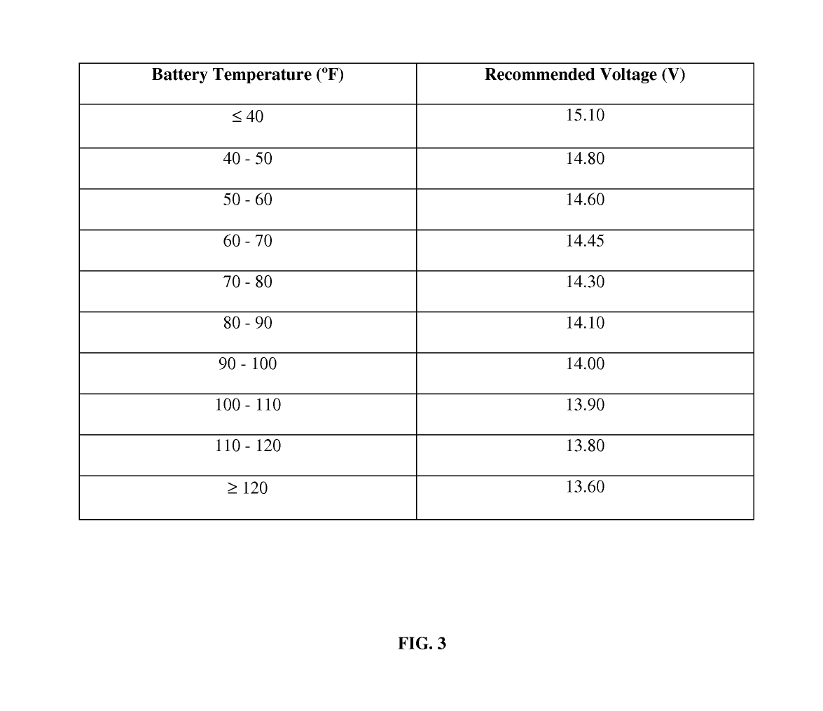

An exemplary voltage/temperature relationship for a battery is illustrated in the table of FIG. 3. The data for this table is made publicly available by East Penn Manufacturing Company, Inc. of Lyon Station, Pa.

As the ambient temperature increases, the (recommended or optimum) voltage to which the battery is charged has to be reduced. Conversely, as the ambient temperature decreases, the voltage to which the battery is charged has to be increased.

Exemplary embodiments implement a temperature sensor for measuring the battery temperature in addition to the voltage sensor. The measurements from each of these sensors may be provided to an engine electronic control unit (EECU) of the vehicle. EECUs are known and are not described further.

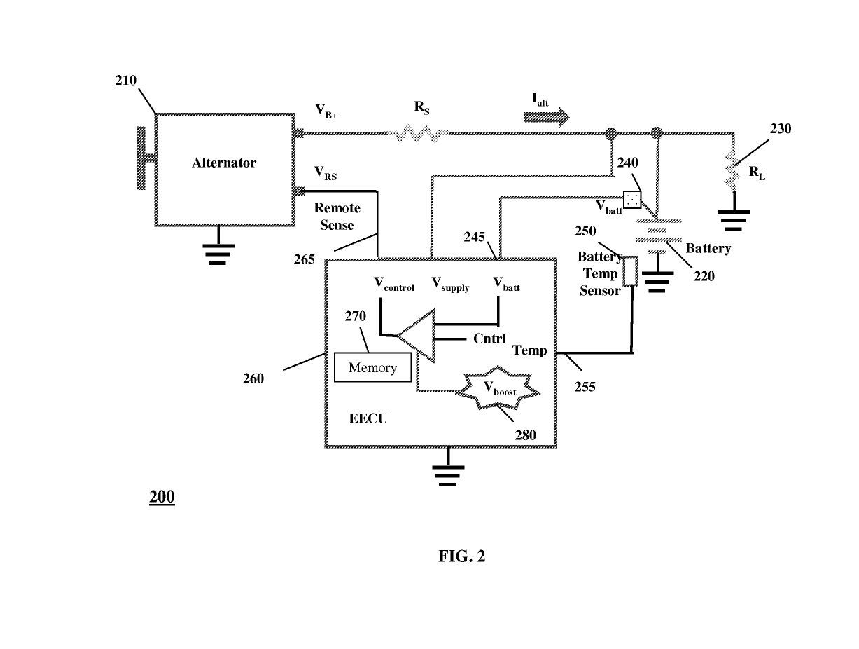

A system in accordance with exemplary embodiments is illustrated in FIG. 2. System 200 may include an alternator 210, a battery 220 connected to alternator 210 (in series) and load 230 connected (in parallel) to the battery. System 200 may also include voltage sensor 240 for measuring the voltage of the battery 220.

The connection between the alternator 210 and the battery 220 can include line resistance R_{S} resulting in a voltage drop across R_{S}. The voltage drop V_{RS} across R_{S} is the product of the resistance R_{S} and the alternator current Iₐₗₜ (i.e. V_{RS}=Iₐₗₜ*R_{S}).

System 200 may further include a temperature sensor 250 for measuring the ambient temperature of battery 220. The resistance in the lines 245 and 255 which communicate measured battery and voltage values from battery sensor 250 and voltage sensor 240 respectively is not negligible. The current in these lines is small. The voltage across lines 245 and 255 is negligible.

The measured values from each of the sensors 240 and 250 may be provided to EECU 260. EECU 260 may include, or have access to, a storage or memory device 270. Memory device 270 can have stored therein a voltage/temperature chart or table (such as that illustrated in FIG. 3) for the battery that is included in the vehicle corresponding to EECU 260.

As described above, the table of FIG. 3 may include recommended voltage charging levels for various ambient temperatures. These voltage levels may be considered to be the optimum for the corresponding temperature.

The measured values received by EECU 260 may be compared with the stored values to determine if the measured voltage of battery 220 is appropriate for the measured ambient battery temperature.

If the measured voltage is determined to be too high for the measured temperature, the EECU may provide a “high” voltage signal to alternator 210. The alternator 210 may then reduce the voltage supplied to the battery 220. As the temperature increases, the battery voltage may need to be reduced to conform to the manufacturer recommendations.

If the measured voltage is too low for the measured temperature, the EECU may provide a “low” voltage signal to alternator 210. The alternator 210 may then increase the voltage supplied to the battery 220. As the temperature decreases, the battery voltage may need to be increased to conform to the manufacturer recommendations.

EECU 260 may include circuitry configured to evaluate voltage and temperature measurements from sensors 240 and 250. Supply voltage (V_{B+}−[R_{S}*Iₐₗₜ]) provides operating power for EECU 260. EECU 260 may include a CTRL line which can be adjusted based on comparing the measured values (from voltage and temperature sensors) with the stored values. The signal, designated V_{control}, may then be provided to alternator 210 via line 275. The control signal may be an analog continuous voltage control signal.

In order to reduce the alternator output voltage (with increasing battery temperature), V_{control} signal has to remain high (in some cases, higher than the supply voltage to EECU 260). However, V_{control} cannot be greater than the supply voltage. A high value for V_{control} can be achieved by utilizing a voltage boosting source. In some embodiments, EECU 260 may include a supplemental voltage boosting source such as V_{boost} 280 shown in FIG. 2.

Boosting of voltage is a known concept. A DC-DC converter can be used for increasing a DC voltage. In exemplary embodiments, DC-DC converter components can be implemented in the EECU 260 in a boost configuration. EECU 260, therefore, may almost always utilize the boost circuit when the alternator output voltage has to be reduced.

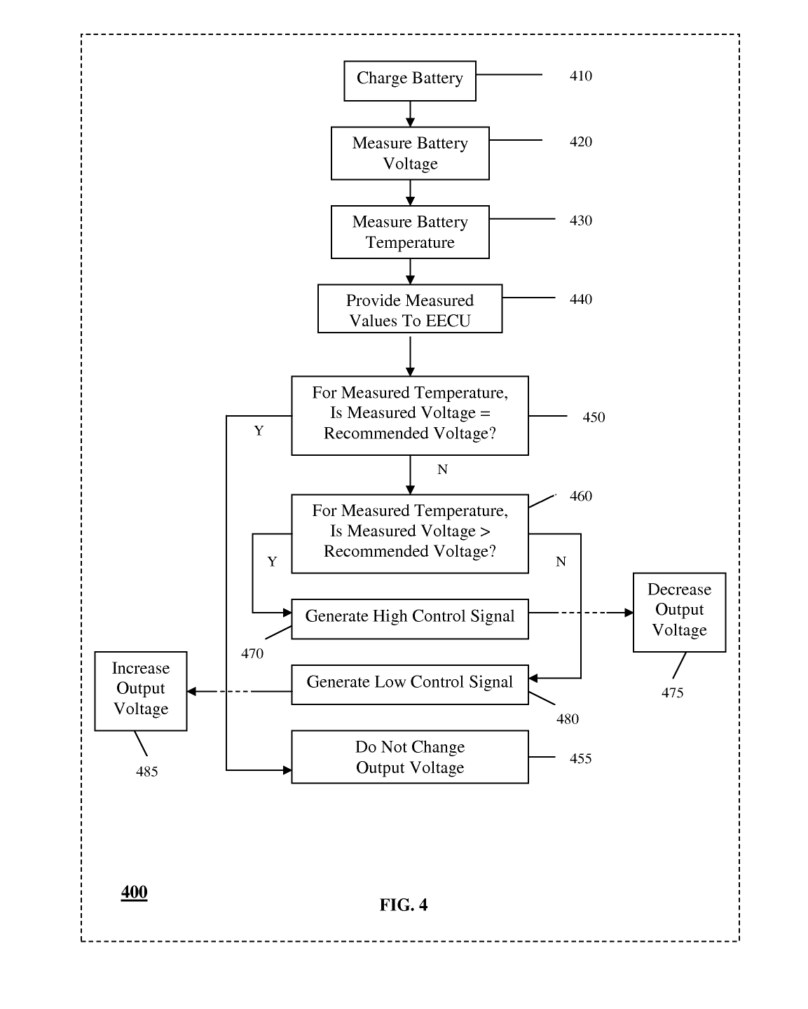

A method 400 in accordance with exemplary embodiments may be described with reference to FIG. 4. An alternator in a vehicle (such as a truck or an automobile) may charge the vehicle battery while the vehicle is running (i.e. the engine is on) at 410. The alternator may charge the vehicle battery to a level for which the battery is rated. The battery voltage may be measured at 420. The ambient battery temperature may be measured at 430. The measurements may be provided to the EECU at 440.

The measured values may then be evaluated. The evaluation may include comparing the measured values with recommended voltage values for the measured temperature for the particular battery (in the truck). The recommended voltage values corresponding to a plurality of temperatures may be stored in a memory (in a table for example) that is accessible to the EECU or may even be within the EECU.

A determination may be made at 450 as to whether the measured voltage level is equal to the recommended voltage level for the measured temperature (Is V_{battery measured}=V_{battery recommended} for T_{measured}?). If they are equal, then it is determined at 455 that no adjustment to the alternator output voltage is needed (i.e. a control signal is not changed).

If the measured values are not equal, then a determination may be made at 460 as to whether the measured voltage level is greater than the recommended voltage level for the measure temperature (Is V_{battery measured}>V_{battery recommended} for T_{measured}?). If the measured value is greater than the recommended value, a high control signal (continuous analog signal) may be generated by the EECU and provided to the alternator at 470. In response to the high control signal, the alternator may decrease its output voltage level at 475.

If the measured value is not greater than the recommended value (i.e. the measured value is lower since it is also not equal to the recommended value), a low control signal (continuous analog signal) may be generated by the EECU and provided to the alternator at 480. In response to the low control signal, the alternator may increase its output voltage level at 485.

The alternator, therefore, adjusts its output voltage based on the control signal received from the EECU. If the signal is high, the output voltage is reduced; if the signal is low, the output voltage is increased. In some cases, the high signal generated by the EECU may be supplemented by a voltage boosting source as described above.

Although exemplary embodiments have been disclosed, it will be apparent to those skilled in the art that various changes and modifications can be made which will achieve some of the advantages of embodiments without departing from the spirit and scope of the disclosure. Such modifications are intended to be covered by the appended claims in which the reference signs shall not be construed as limiting the scope. While exemplary embodiments cite a truck or an automobile, the various aspects described herein may be equally applicable wherever an alternator is used to charge a battery.

Further, in the description and the appended claims the meaning of “comprising” is not to be understood as excluding other elements or steps. Further, “a” or “an” does not exclude a plurality, and a single processor or other unit may fulfill the functions of several means recited in the claims.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

For instance, the foregoing detailed description has set forth various embodiments of the devices and/or processes via the use of block diagrams and examples. Insofar as such block diagrams and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof.

In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In the following claims, the terms used should not be construed to limit the claims to the specific embodiments disclosed in the specification and the claims, but should be construed to include all possible embodiments along with the full scope of equivalents to which such claims are entitled. The claims are not limited by the disclosure.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for adjusting a voltage level to which a battery is charged, the system comprising:
an alternator;
a battery connected in series to the alternator;
at least one electrical load element connected in parallel to the battery;
a plurality of sensors connected to the battery;
an engine electronic control unit (EECU) having as inputs at least a signal from each of the plurality of sensors and providing a continuous analog voltage control signal to the alternator wherein the alternator comprises a voltage regulator for adjusting the output voltage of the alternator based on the continuous analog voltage control signal received from the EECU.

2. The system of claim 1, wherein the plurality of sensors comprises:
a voltage sensor for measuring the voltage of the battery.

3. The system of claim 2, wherein the plurality of sensors comprises:
a temperature sensor for measuring the temperature of the battery.

4. The system of claim 3, wherein the EECU comprises:
a memory for storing data for the battery, the data including a plurality of recommended battery charging voltage values with each value corresponding to a particular battery temperature value.

5. The system of claim 4, wherein the EECU comprises:
a processor for comparing values obtained from the sensors with the stored battery data and for generating the voltage control signal.

6. The system of claim 5, wherein the voltage control signal provided by the EECU is a high signal if the measured voltage of the battery is greater than the recommended battery charging value for the measured temperature.

7. The system of claim 5, wherein the voltage control signal provided by the EECU is a low signal if the measured voltage of the battery is less than the recommended battery charging value for the measured temperature.

8. The system of claim 1, wherein the EECU comprises:
a voltage boosting circuit for increasing the voltage control signal to a level higher than a supply voltage of the EECU.

9. A method for adjusting a voltage level to which a battery is charged, the method comprising the steps of:
charging the battery by an alternator;
measuring a plurality of parameters associated with the battery;
communicating the measured parameters to an engine electronic control unit (EECU);
evaluating the measured parameters;
generating a continuous analog voltage control signal based on the evaluation;
communicating the continuous analog voltage control signal to the alternator; and
adjusting the supply voltage provided by the alternator to the battery based on the communicated continuous analog voltage control signal wherein the alternator comprises a voltage regulator for adjusting the supply voltage of the alternator.

10. The method of claim 9, comprising measuring a voltage level of the battery and measuring a temperature of the battery.

11. The method of claim 10, comprising:
comparing the measured voltage level with a pre-stored recommended voltage level for the measured temperature.

12. The method of claim 11, comprising:
generating a high voltage control signal if the measured voltage level is greater than the recommended voltage level.

13. The method of claim 12, comprising:
decreasing the voltage output level to which the battery is charged with the generation of the high voltage control signal.

14. The method of claim 11, further comprising:
generating a low voltage control signal if the measured voltage level is less than the recommended voltage level and increasing the voltage output level to which the battery is charged.

15. The method of claim 9, comprising:
boosting the high voltage control signal value above a supply voltage of the EECU via a boosting circuit.
